(19) United States
(12) Patent Application Publication
(10) Pub. No.: US 2010/0299214 A1
(43) Pub. Date: Nov. 25, 2010

(54) TIME DIFFERENTIATION BASED ADVERTISING

(75) Inventor: Anuj SAHAI, Bangalore (IN)

Correspondence Address: Evergreen Valley Law Group, P.C. and Yahoo! Inc., 4 South Second Street, Suite 598, San Jose, CA, 95113, US

(73) Assignee: Yahoo! Inc., Sunnyvale, CA (US)

(21) Appl. No.: 12/470,490

(22) Filed: May 22, 2009

(51) Int. Cl. G06Q 30/00; G06F 15/16

(52) U.S. Cl. 705/14.71; 709/206

(57) ABSTRACT

Time differentiation based advertising. A method includes receiving bids for a content category from a first content provider and a second content provider. The method also includes determining a time difference between initiation of an action corresponding to the first content provider and corresponding to the second content provider based on the content category and the bids. Further, the method includes electronically initiating the action corresponding to the first content provider in response to an input associated with the first content provider. Furthermore, the method includes electronically initiating the action corresponding to the second content provider in response to an input associated with the second content provider after a time equivalent to the determined time difference has elapsed.

### BACKGROUND

In the current scenario, advertisements or contents are provided to a user in response to an input from the user. Typically, a uniform resource locator (URL) of a website of an advertiser or a content provider is provided to the user. The user can then click the URL to explore details provided by the advertiser or the content provider. However, some advertisers may not have a website and hence, such advertisers may not be able to reach out to a wide range of potential customers available online. Further, when several advertisements are displayed to the user together not much advantage is offered to the advertiser who might otherwise want to get advantage over other advertisers.

In light of foregoing discussion there is a need for a technique for advertising that overcomes the above-mentioned issues.

### SUMMARY

Embodiments of the present disclosure described herein provide a method, system, and article of manufacture for time differentiation based advertising.

An example for a method includes receiving bids, electronically, for a content category from a first content provider and a second content provider. The method also includes determining a time difference between initiation of an action corresponding to the first content provider and corresponding to the second content provider based on the content category and the bids. Further, the method includes electronically initiating the action corresponding to the first content provider in response to an input associated with the first content provider. Furthermore, the method includes electronically initiating the action corresponding to the second content provider in response to input associated with the second content provider after a time equivalent to the determined time difference has elapsed.

An example for a method includes receiving bids, electronically, for a content category from a plurality of advertisers. The method also includes determining relative times for initiation of communication between a prospective customer and each advertiser based on the content category and the bids. Further, the method includes electronically providing advertisements of the plurality of advertisers in response to an input associated with the content category. Furthermore, the method includes electronically initiating communication between a first advertiser of the plurality of advertisers and the prospective customer in response to an input indicative of selection of the first advertiser. Moreover, the method includes electronically initiating communication between a second advertiser of the plurality of advertisers and the prospective customer in response to an input indicative of selection of the second advertiser after a predetermined time has elapsed.

An example of an article of manufacture includes a machine readable medium. The machine-readable medium carries instructions operable to cause a programmable processor to perform receiving bids, electronically, for a content category from a first content provider and a second content provider. Further, the machine-readable medium carries instructions operable to cause a programmable processor to perform determining a time difference between initiation of an action corresponding to the first content provider and corresponding to the second content provider based on the content category and the bids. Furthermore, the machine-readable medium carries instructions operable to cause a programmable processor to perform electronically initiating the action corresponding to the first content provider in response to an input associated with the first content provider. Moreover, the machine-readable medium carries instructions operable to cause a programmable processor to perform electronically initiating the action corresponding to the second content provider in response to input associated with the second content provider after a time equivalent to the determined time difference has elapsed.

An example of a system includes a communication interface in electronic communication with a plurality of electronic devices to receive bids for a content category from a first content provider and a second content provider. Further, the system includes a memory that stores instructions. Furthermore, the system includes a processor responsive to the instructions to determine a time difference between initiation of an action corresponding to the first content provider and corresponding to the second content provider based on the content category and the bids, to initiate the action corresponding to the first content provider in response to an input associated with the first content provider, and to initiate the action corresponding to the second content provider in response to an input associated with the second content provider after a time equivalent to the determined time difference has elapsed.

### BRIEF DESCRIPTION OF THE FIGURES

FIG. 1 is a block diagram of an environment, in accordance with which various embodiments can be implemented;

FIG. 2 is a flowchart illustrating a method for bidding for time differentiated actions, in accordance with one embodiment.

FIG. 3 is a flowchart illustrating a method for advertising, in accordance with one embodiment;

FIG. 4 is a flowchart illustrating method steps performed by a prospective customer, in accordance with one embodiment;

FIG. 5 is a flowchart illustrating method steps performed by a content provider, in accordance with one embodiment; and

FIG. 6 is a block diagram of a server, in accordance with one embodiment.

### DETAILED DESCRIPTION OF THE EMBODIMENTS

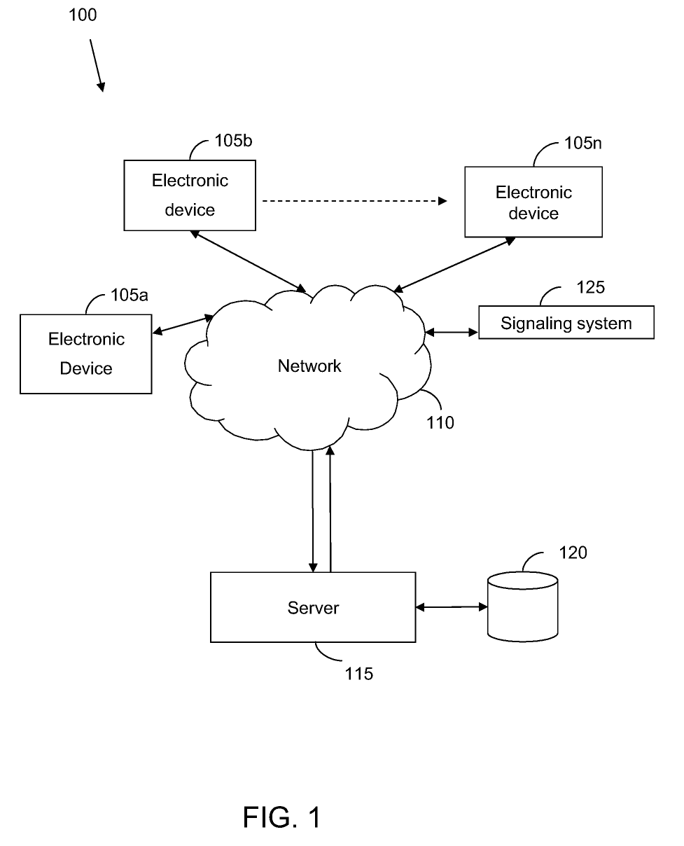

FIG. 1 is a block diagram of an environment 100, in accordance with which various embodiments can be implemented. The environment 100 includes one or more electronic devices, for example an electronic device 105a, an electronic device 105b, and an electronic device 105n, connected to a network 110. Examples of the electronic devices include, but are not limited to, computers, laptops, mobile devices, hand held devices, telecommunication devices and personal digital assistants (PDAs). Examples of the network 110 include but are not limited to a Local Area Network (LAN), a Wireless Local Area Network (WLAN), a Wide Area Network (WAN), internet and a Small Area Network (SAN). The network 110 can also include a telecommunication network for linking to the telecommunication devices.

The electronic devices are also connected to a server 115 through the network 110. The server 115 is connected to a storage device 120. The server 115 is also in communication with a signaling system 125 via the network 110 through a link. Examples of the signaling system 125 include, but are not limited to, a short service message (SMS) gateway, an electronic mail (email) gateway, a global system for mobile communications (GSM) gateway, and a media gateway. The server 115 renders information to the electronic devices via the network 110 by using the signaling system 125 through the link.

In various embodiments, the electronic device 105a can be a prospective customer electronic device, the electronic device 105b can be a first content provider electronic device and the electronic device 105n can be a second content provider electronic device.

A content provider can be an advertiser or any other entity interested in providing contents to a prospective customer. Each content provider sends bids corresponding to a content category using an electronic device, for example, electronic device 105a, of the content provider to gain advantage in time of receiving information regarding the prospective customer over other content providers. The bids are received by server 115 through the network 110 from the electronic devices. The server 115 can also receive contact details, name and other details from each content provider at the time bidding or at any other time. The server 115 determines relative times at which an action corresponding to each content provider needs to be initiated based on the content category and the bids.

In some embodiments, each content provider can be ranked based on the bids. In alternative embodiments, other parameters, for example reputation of the content provider, history of the content provider, and customer response towards the content provider can also be considered while ranking. The ranking of the each content provider can be stored in the storage device 120 and can be accessed by the server 115.

The server 115 can initiate the actions in response to an input associated with at least one of the first content provider and the second content provider. Examples of the input include, but are not limited to, clicking, checking a box, and entering a keyword. The server 115 initiates the action corresponding to the first content provider in response to the input associated with the first content provider. The server 115 also initiates the action corresponding to the second content provider in response to the input associated with the first content provider after a time equivalent to the determined time difference has elapsed. The server 115 initiates the action corresponding to at least one of the content providers by sending an electronic message to that content provider by using the signaling system 125 through the link.

Examples of the actions include, but are not limited to, displaying advertisements, displaying contents, initiating communication between the prospective customer and a content provider, forwarding details of the prospective customer to a content provider and any other action capable of being differentiated based on time. The server 115 can initiate the actions using the signaling system 125. The server 115 can direct short service messages, emails, telephone calls, voice messages, and other similar communication services to the electronic devices by using the signaling system 125 through the link.

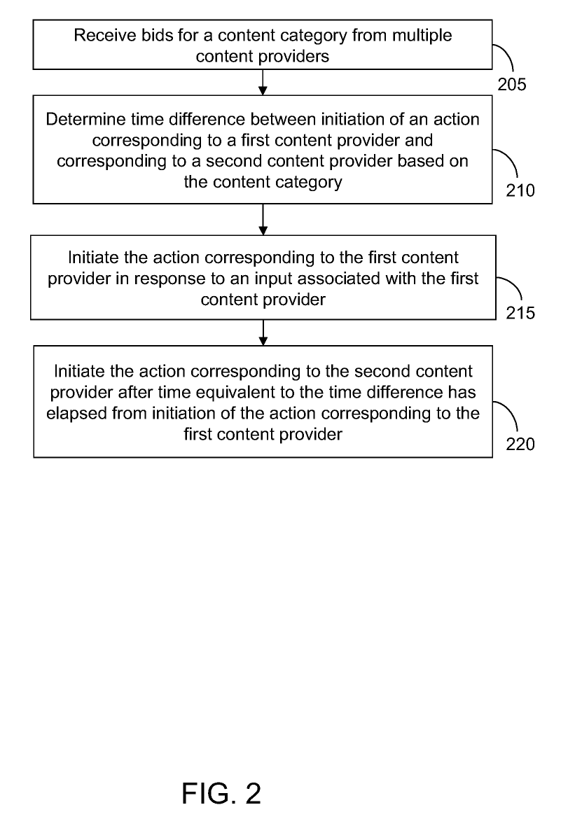

FIG. 2 is a flowchart illustrating a method for bidding for time differentiated actions, in accordance with one embodiment.

At step 205, bids are received for a content category from a first content provider and a second content provider. A content provider can be an advertiser or any other entity interested in providing contents or advertisements to a prospective customer. For example, when the prospective customer searches for a house on Yahoo® Real Estate, several predefined contents from various content providers are provided to the prospective customer as results, and advertisements from the advertisers can also be displayed. Examples of the contents and advertisements include, but are not limited to, uniform resource locators (URLs) of the websites of the advertisers and the content providers, contact details, names, virtual contact numbers, proxy numbers and phone numbers. The name and contact details can be collected from the content providers.

The contents including advertisements can be categorized based on content categories. Example of the content categories include, but are not limited to, real estate, electronics, software, food, movies, sports, news, maps, travel, and jobs. Each content provider bids for prioritizing itself and to obtain advantage over other content providers.

The bidding can be performed separately for each content category. For example, when a content provider logs into its account on Yahoo® search marketing, options can be provided to the content provider to allocate a certain amount as a bid for prioritizing itself. Each content category can include a plurality of sub-categories. The bids can be received separately for sub-categories also. The bids can also be received separately for each keyword within a category.

The bidding can be performed using mobile phones by sending a message to a dedicated number. Various other modes for bidding can be used, for example, telephone call, credit card transaction, and electronic transfer.

The bids from each content provider include different bids for different actions. Separate bids can also be received for the same action for different content categories. Examples of the actions includes, but are not limited to, displaying contents of the first content provider and the second content provider to the prospective customer, providing contact details of the prospective customer to at least one of the first content provider and the second content provider via communication instruments, and establishing electronic communication between the prospective customer and at least one of the first content provider and the second content provider.

In some embodiments, the communication between the prospective customer and each content provider can be established by hiding contact details of the prospective customer and each content provider from each other respectively. A proxy number corresponding to the contact details of a content provider can be assigned. The proxy number can then be displayed to the prospective customer, thereby hiding the contact details of the content provider. For example, a first proxy number can be assigned to the first content provider and a second proxy number can be assigned to the second content provider. The first proxy number can be displayed when displaying the content of the first content provider and the second proxy number can be displayed when displaying the content of the second content provider.

The bids include allocation of a certain amount towards time based prioritization apart from allocation towards other options. For example, the bid for forwarding contact details of the prospective customer to a content provider can include allocation of amount per prospective customer and allocation of amount towards time based advantage for receiving the contact details of the prospective customer prior to providing the contact details to other content providers.

Various parameters can be communicated to each content provider prior to bidding. For example, minimum bid for the content category, and average bids for the content category. Each content provider can periodically alter its bids based on preferences of the content provider.

In some embodiments, each content provider can be ranked based on the bids. For example, consider the first content provider and the second content provider as content providers with varying bids corresponding to the content category. If the first content provider bids higher than the second content provider, then the first content provider is ranked first and the second content provider is ranked second respectively.

At step 210, a time difference between initiation of an action corresponding to the first content provider and corresponding to the second content provider is determined based on the content category and the bids. For example, a fixed time difference can be determined between initiations of the action for the first content provider and the second content provider based on the bids. Consider the first content provider having a higher bid corresponding to the content category in comparison to the second content provider. The time difference then corresponds to the time between the initiation of the action corresponding to the first content provider with the higher bid and the initiation of the action corresponding to the second content provider with a lower bid in comparison to the first content provider.

The time difference can be referred to as predetermined time and can be different for different content categories. The time difference can be predefined for each content category. The time difference is also determined based on the bids. For the “pizza” category the time difference might be 15 seconds between displaying contents from the first content provider with the higher bid and displaying contents from the second content provider with a comparatively lower bid, while for the “interior designers” category the time difference might be 40 seconds. The time difference can also be different for different actions. For example, the time difference can be 30 seconds between display of contents from the first content provider and the second content provider. The time difference can be 1 hour for forwarding contact details of the prospective customer first to the first content provider and then to the second content provider respectively in sequence. In another aspect, the time difference can be a function of several parameters, for example, bids, content categories and action to be performed. Weights can be assigned to different parameters and time difference can be determined based on the weights. For example, if the highest bid is $500 from the first content provider and $100 from the second content provider then the time difference between displaying advertisements of the first content provider with $500 bid can be made higher than the time difference between displaying advertisements of the second content provider with $100 bid.

At step 215, the action corresponding to the first content provider is initiated electronically in response to an input associated with the first content provider. The input can include, but is not limited to, prospective customer profile information, a search query made by the prospective customer, keyword, prospective customer history, and prospective customer activity. The input from the prospective customer can be determined by tracking the prospective customer activity and through browser cookies. Each input from the prospective customer can initiate an associated action corresponding to the first content provider. For example, when the prospective customer first inputs a search query, a first action of displaying contents from the first content provider to the prospective customer is initiated. Upon display of the contents, if the prospective customer then inputs a request for communication with the first content provider, a second action of establishing communication or forwarding contact details of the prospective customer to the first content provider is initiated.

At step 220, the action corresponding to the second content provider is initiated electronically in response to an input associated with the second content provider after a time equivalent to the determined time difference has elapsed. Each action initiated corresponding to the first content provider is reinitiated corresponding to the second content provider after the time equivalent to the time difference has elapsed. For example, if the action of displaying the contents from the first content provider to the prospective customer is initiated, then the action of displaying of the contents from the second content provider to the prospective customer is initiated after the time equivalent to the time difference has elapsed from the display of the contents from the first content provider to the prospective customer.

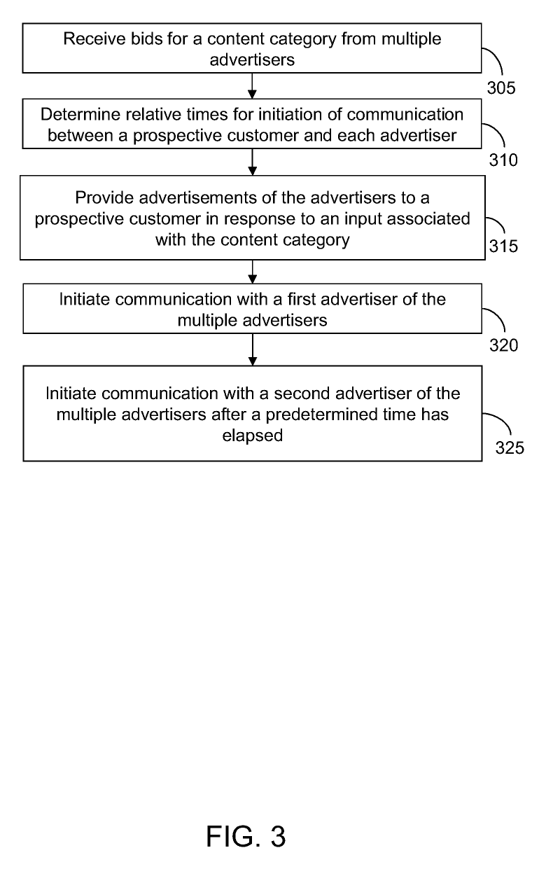

FIG. 3 is a flowchart illustrating a method for advertising, in accordance with one embodiment.

At step 305, bids are received electronically for a content category from multiple advertisers. Example of the content categories include, but are not limited to, real estate, technology, food, movies, sports, news, maps, travel, and jobs. Each content category can include a plurality of sub-categories. For example, the “food category” can include fast food, pizza, sweets, and packaged products. The bids can be received separately for sub-categories also. The bids can also be received separately for each keyword within a category. For example, in the “technology” category separate bids can be received for different keywords such as computer, and electronics.

The bids can be received through various modes of communication, for example short service messages, voice calls, instant messages, electronic transfer, online account access, and electronic mails. Separate bids can be received for different actions for the same content category. Separate bids can also be received for the same action for different content categories. Examples of the actions include, but are not limited to, displaying contents of the first content provider and the second content provider to a prospective customer, providing contact details of the prospective customer to at least one of the first content provider and the second content provider via communication instruments, and establishing electronic communication between the prospective customer and at least one of the first content provider and the second content provider.

The bids include allocation of a certain amount towards time based prioritization apart from allocation towards other options. For example, the bid for forwarding contact details of the prospective customer to an advertiser can include allocation of amount per prospective customer and allocation of amount towards time based advantage for receiving the contact details of the prospective customer first.

Various parameters, for example, minimum bid for the content category, and average bids for the content category can be communicated to each advertiser prior to bidding. Each advertiser can periodically alter its bids based on its own preferences.

At step 310, relative times are determined for initiation of communication between the prospective customer and each advertiser based on the content category and the bids. The time difference can be referred to as predetermined time and can be different for different content categories. For the pizza category the time difference can be 15 seconds between displaying advertisements from a first advertiser with a highest bid and displaying advertisements from a second advertiser with a comparatively lower bid than the first advertiser while for the interior designers category the time difference can be 40 seconds. The time difference can also be different for different actions. For example, the time difference can be 30 seconds between display of advertisements from the first advertiser with the highest bid and the second advertiser with comparatively lower bid respectively while the time difference can be 1 hour between forwarding contact details of the prospective customer to the first advertiser and the second advertiser respectively. In another aspect, the time difference can be a function of several parameters, for example bids, content categories, and action to be performed. Weights can be assigned to different parameters and time differences can be determined based on the weights. For example, if the highest bid is $500, followed by $100 and $90 then the time difference between displaying advertisements of the advertiser with $500 bid and of the advertiser with $100 bid can be made higher than the time difference between displaying advertisements of the advertiser with $100 bid and of the advertiser with $90 bid.

In some embodiments, the advertisers are ranked based on the bids. The relative times can be determined based on the rank of the advertiser. For example, the advertiser with highest bid can be ranked first. In alternative embodiments, other parameters for example, reputation of the advertiser, history of the advertiser, customer response towards the advertiser, and revenue maximization can also be considered while ranking. The ranking of the advertisers can then be stored. A fixed time difference can be determined between initiations of the action for two advertisers with consecutive ranks.

In some embodiments, the first advertiser of the multiple advertisers is referred to as the advertiser with highest bid or ranking and the second advertiser of the multiple advertisers is referred to as the advertiser with the comparatively lower bid or subsequent ranking.

At step 315, the advertisements from the advertisers are provided in response to an input associated with the content category. The input can include, but is not limited to, prospective customer profile information, a search query made by the prospective customer, keyword, prospective customer history, and prospective customer activity. The input from the prospective customer can be determined by tracking the prospective customer activity and through browser cookies.

Examples of the advertisements include, but are not limited to, URLs, contact details, names, virtual contact numbers, proxy numbers and phone numbers. In some embodiments, each advertiser can be assigned a proxy number and the proxy number of the each advertiser can be displayed. The proxy number helps in hiding contact details of the advertiser from the prospective customer.

In one embodiment, the advertisements from the advertisers can be provided at predefined relative times. For example, the advertisements from the first advertiser with highest bid among all advertisers can be provided instantaneously and the advertisements from the second advertiser with a comparatively lower bid than the first advertiser can be provided after a predefined time has elapsed. The predefined time can be defined as the time difference between displays of advertisements from two advertisers with subsequent higher and lower bids respectively. The predefined time can be different for different pair of advertisers. The predefined time can be different from or equivalent to the predetermined time.

In alternative embodiments, the advertisements from the advertisers can be provided without any time differentiation.

In some embodiments, a request from the prospective customer to initiate communication with the advertisers is received. The prospective customer can be provided with an option to select the advertisers with whom the prospective customer wants to initiate the communication.

In some embodiments, the prospective customer may be prompted to provide information such as contact details, name, preferred time for contacting, queries, clarifications, complaints, details of discount coupons and the like. The prospective may also be provided with an option to initiate communication with the first advertiser and with the second advertiser.

At step 320, communication with the first advertiser of the multiple advertisers is initiated in response to an input indicative of selection of the first advertiser. In one embodiment, when the proxy number is displayed the initiation includes establishing electronic communication between the prospective customer and an advertiser without providing contact details of the prospective customer to the advertiser and without providing contact details of the advertiser to the prospective customer. When the prospective customer clicks on the proxy number a call is made to a real number of the advertiser mapped to the proxy number. In another embodiment, the initiation includes electronically forwarding the contact details of the prospective customer to the advertiser. The contact details can be forwarded using short service message, instant message and electronic mail.

At step 325, the communication is initiated with a second advertiser of the multiple advertisers having subsequent ranking in response to an input indicative of selection of the second advertiser after the predetermined time has elapsed.

In some embodiments, option can be provided to an advertiser to initiate a test run to determine latency or time taken for initiation of an action corresponding to the advertiser in comparison to initiation of the action corresponding to the other advertisers. Results of the test run can indicate latency.

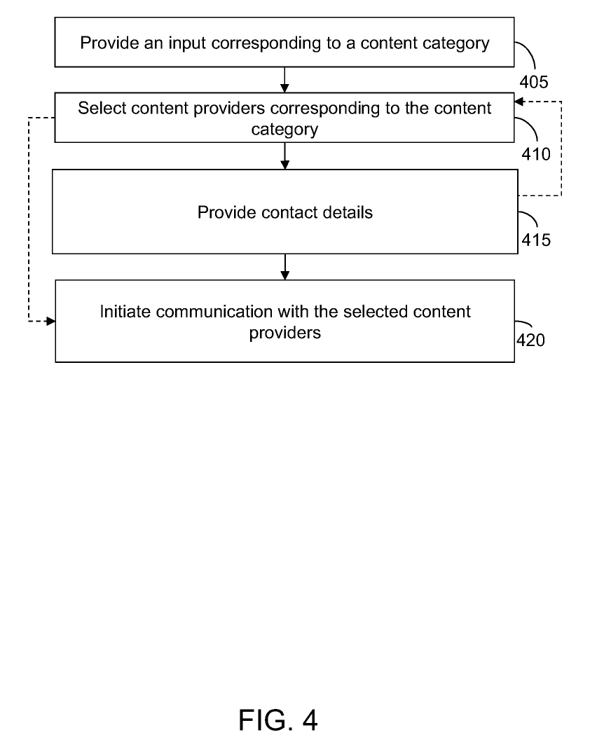

FIG. 4 is a flowchart illustrating method steps performed by a prospective customer, in accordance with one embodiment.

At step 405, the prospective customer provides an input. The input is used for determining a content category. For example, the prospective customer can enter a search query using a search engine such as Yahoo® Search. The search query includes keywords which can be used for identifying the content category. In another aspect, the prospective customer can be checking emails or working on a browser. The context can be identified through browser cookies or any other mode which can then be used to determine the content category.

The contents obtained from content providers corresponding to the content category are then provided to the prospective customer in response to the input. For example, if the prospective customer enters the search query “restaurant, Bangalore” then the content category can be identified as “restaurant” and names of the restaurants in “Bangalore” are displayed. Along with the names other details such as phone numbers, addresses can also be displayed based on preferences of the content providers. In addition advertisements can also be displayed separately. The contents and advertisements can be displayed together or can be time differentiated.

At step 410, the prospective customer selects the contents including the advertisements which are of interest to the prospective customer.

In some embodiments, at step 415, the prospective customer can be prompted to provide additional details, for example name, mobile number, and preferences.

In some embodiments, step 410 can be performed after step 415.

At step 420, communication is initiated between the prospective customer and the selected content providers by the prospective customer. The communication can directly be established between the prospective customer and each content provider selected if the option is provided to the prospective customer to connect to the content providers. Alternatively, contact details of the prospective customer can be forwarded to each content provider selected and each content provider can then approach the prospective customer. The communication can be time differentiated.

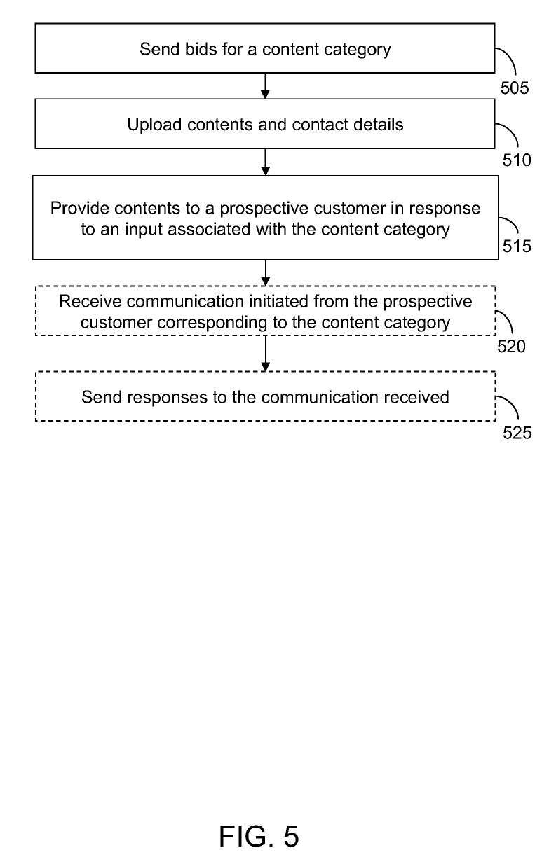

FIG. 5 is a flowchart illustrating method steps performed by a content provider, in accordance with one embodiment.

A time differentiation based advertising option is provided to a content provider.

At step 505, the content provider bids for a content category for which the content provider desires to attract a prospective customer. The content provider can bid for the content category by allocating an amount for time based prioritization for various actions. The content provider can send different bids for different actions. For example, the content provider can bid for displaying its contents prior to other content providers. Each content provider can also bid to receive contact details of the prospective customer or to establish communication with the prospective customer prior to other content providers.

In addition, the content provider can also define monetary limits and constraints for other activities, for example cost per prospective customer referral. In some embodiments, the content provider can also subscribe for a proxy number to hide details from the prospective customer.

At step 510, the content provider uploads contents including contact details of the content provider, URL, name and other details. The uploading can be performed in various ways, for example through short message service, uploading on a server, or any other electronic mode.

In some embodiments, step 505 can be performed after step 510.

At step 515, the contents of the content provider are provided to the prospective customer in response to an input from the prospective customer corresponding to the content category. The input from the prospective customer can be received, for example, through the internet, a short service message, email, or voice call.

At step 520, the content provider receives communication initiated by the prospective customer. The content provider can receive contact details of the prospective customer or can receive direct call from the prospective customer through a server.

In some embodiments, at step 525, the content provider sends responses to the communication received. If the content provider receives the contact details of the prospective customer, then the content provider can directly initiate communication with the prospective customer using the contact details.

The methods described above have been explained with help of examples below.

### EXAMPLE 1

Content provider A bids $5, content provider B bids $1, and content provider C bids $2 for displaying contents in response to an input from a prospective customer corresponding to a content category “pizza”. The content provider A with a higher bid than the content provider B and than the content provider C is ranked first (highest bid). The content provider C with a higher bid than the content provider B is ranked second. The content provider B with the least bid in comparison to the content provider A and the content provider C is ranked third. For the content category “pizza”, the time difference between the display of the contents from each content provider can be 30 seconds per $1. Hence, the time difference between the display of contents from the content provider A and the content provider C can be determined as 90 seconds (30*[5−2]), and the time difference between the display of contents from the content provider B and the content provider C can be determined as 30 seconds.

The prospective customer inputs a search query “pizza” using an online search engine, for example, Yahoo® Search. The contents of the content provider A, ranked first, is displayed to the prospective customer first. The contents of the content provider C, ranked second, is displayed to the prospective customer after 90 seconds. The contents of the content provider B, ranked third, is displayed to the prospective customer 30 seconds after the display of the contents of the content provider C and 120 seconds after the display of the contents of the content provider A.

### EXAMPLE 2

Content provider A bids $3, content provider B bids $1, and content provider C bids $2 for forwarding the contact details of a prospective customer corresponding to a content category “pizza”. The content provider A having a higher bid than the content provider B and than the content provider C is ranked first. The content provider C with a higher bid than the content provider B is ranked second. The content provider B with the least bid in comparison to the content provider A and the content provider C is ranked third. If bids from only the content provider B and the content provider C are considered, then content provider C with a higher bid than the content provider B is ranked first and the content provider B is ranked second. If bids from only the content provider A and the content provider B are considered, then content provider A with a higher bid than the content provider B is ranked first and the content provider B is ranked second. For the content category “pizza”, a predetermined time for forwarding the contact details of the prospective customer between at least two content providers can be 30 seconds.

The prospective customer inputs a search query “pizza” using an online search engine, for example, Yahoo® Search. The contents of the content provider A, content provider B, and content provider C are displayed to the prospective customer. The prospective customer provides contact details of the prospective customer to initiate communication with at least two content providers among the content provider A, content provider B, and content provider C in response to contents displayed.

If the prospective customer then inputs a request for communication with the content provider A, content provider B, and content provider C, then the contact details of the prospective customer are forwarded first to the content provider A, ranked first. The contact details of the prospective customer are then forwarded to the content provider C, ranked second, 30 seconds after forwarding the contact details of the prospective customer to the content provider A. The contact details of the prospective customer are then forwarded to the content provider B, ranked third, 30 seconds after forwarding the contact details of the prospective customer to the content provider C.

If the prospective customer inputs request for communication with the content provider B and content provider C, then the contact details of the prospective customer are then forwarded first to the content provider C, ranked first in comparison to the content provider B. The contact details of the prospective customer are then forwarded to the content provider B, ranked second in comparison to the content provider C, 30 seconds after forwarding the contact details of the prospective customer to the content provider C.

If the prospective customer inputs request for communication with the content provider A and content provider B, then the contact details of the prospective customer are then forwarded first to the content provider A, ranked first in comparison to the content provider B. The contact details of the prospective customer are then forwarded to the content provider B, ranked second, in comparison to the content provider A, 30 seconds after forwarding the contact details of the prospective customer to the content provider A.

### EXAMPLE 3

Content provider A bids $5, content provider B bids $1, and content provider C bids $2 for displaying contents in response to an input from a prospective customer corresponding to a content category “pizza”. The content provider A has a higher bid than the content provider C and content provider B. The content provider C has a higher bid than content provider B. However, the content provider C can be more popular and established than the content provider A. The content providers A, B and C can then ranked based on the bids and revenue maximization parameters including reputation of the content provider and history of the content provider. The content provider C is ranked first based on the bids and the revenue maximization parameters. The content provider A is ranked second and the content provider B is ranked third.

For the content category “pizza”, the time difference between display of the contents from each content provider can be 30 seconds per $1. Hence, the time difference between the display of contents from the content provider C and the content provider A can be determined as 90 seconds (30*[5−2]), and the time difference between the display of contents from the content provider A and the content provider B can be determined as 120 seconds.

The prospective customer inputs a search query “pizza” using an online search engine, for example, Yahoo® Search. The contents of the content provider C, ranked first, is displayed to the prospective customer first. The contents of the content provider A, ranked second, is displayed to the prospective customer after 90 seconds. The contents of the content provider B, ranked third, is displayed to the prospective customer 120 seconds after the display of the contents of the content provider A and 210 seconds after the display of the contents of the content provider C.

The prospective customer inputs a request for communication with at least one of the content provider A, the content provider B, and content provider C in response to contents displayed or clicks on the contents displayed corresponding to at least one the content providers.

The ranking of each content provider can also be altered based on the revenue maximization parameters including customer response to each content provider considered over a predefined time. The customer response can include, but is not limited to, number of requests for communication and clicks corresponding to the content of each content provider considered over the predefined time.

If the content provider A receives a greater number of clicks or requests for communication from multiple potential customers than the content provider C over a period of 1 week, then the content provider A, currently ranked second, can be ranked first based on the bids and the revenue maximization parameters, the content provider C, currently ranked first, can be ranked second and the content provider B can be ranked third. The time difference between the display of contents from the content provider A and the content provider C can be determined as 90 seconds (30*[5−2]), and the time difference between the display of contents from the content provider C and the content provider B can be determined as 30 seconds.

For the inputs received from the potential customers corresponding to the search query “pizza” after the period of 1 week, the contents of the content provider A, ranked first, is displayed to the prospective customer first. The contents of the content provider C, ranked second, is displayed to the prospective customer after 90 seconds. The contents of the content provider B, ranked third, is displayed to the prospective customer 30 seconds after the display of the contents of the content provider A and 120 seconds after the display of the contents of the content provider C.

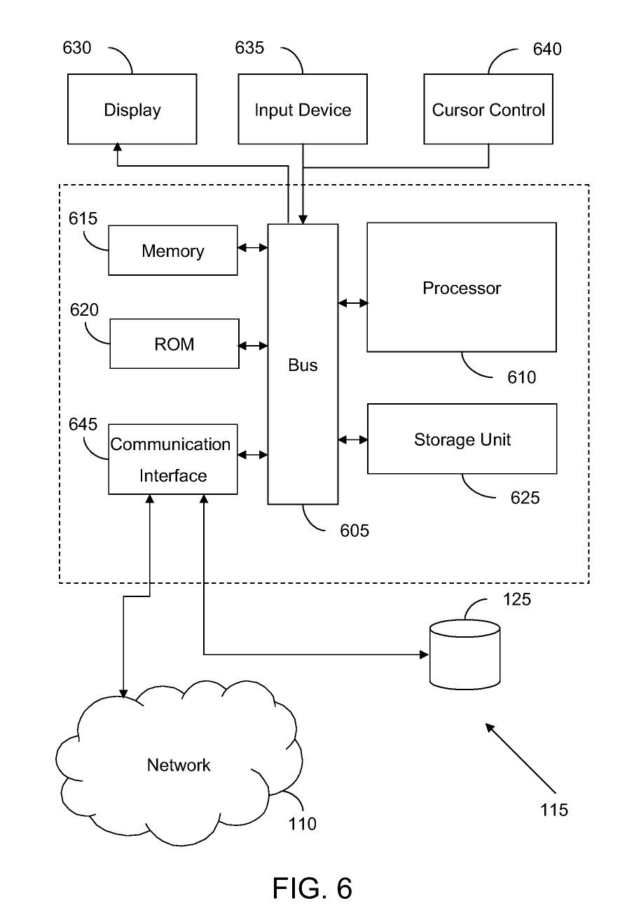

FIG. 6 is a block diagram of a server 115, in accordance with one embodiment. The server 115 includes a bus 605 for communicating information, and a processor 610 coupled with the bus 605 for processing information. The server 115 also includes a memory 615, for example a random access memory (RAM) coupled to the bus 605 for storing instructions to be executed by the processor 610. The memory 615 can be used for storing temporary information required by the processor 610. The server 115 may further include a read only memory (ROM) 620 coupled to the bus 605 for storing static information and instructions for the processor 610. A server storage unit 625, for example a magnetic disk, hard disk or optical disk, can be provided and coupled to the bus 605 for storing information and instructions.

The server 115 can be coupled via the bus 605 to a display 630, for example a cathode ray tube (CRT) or a liquid crystal display (LCD), for displaying information. An input device 635, for example a keyboard, is coupled to the bus 605 for communicating information and command selections to the processor 610. In some embodiments, cursor control 640, for example a mouse, a trackball, a joystick, or cursor direction keys for command selections to the processor 610 and for controlling cursor movement on the display 630 can also be present.

In one embodiment, the steps of the present disclosure are performed by the server 115 in response to the processor 610 executing instructions included in the memory 615. The instructions can be read into the memory 615 from a machine-readable medium, for example the server storage unit 625. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. Storage media can include non-volatile media and volatile media. The server storage unit 625 can be non-volatile media. The memory 615 can be a volatile medium. All such media must be tangible to enable the instructions carried by the media to be detected by a physical mechanism that reads the instructions into the machine.

Examples of the machine readable medium include, but are not limited to, a floppy disk, a flexible disk, hard disk, magnetic tape, a CD-ROM, optical disk, punchcards, papertape, a RAM, a PROM, EPROM, and a FLASH-EPROM.

The machine readable medium can also include online links, download links, and installation links providing the instructions to be executed by the processor 610.

The server 115 also includes a communication interface 645 coupled to the bus 605 for enabling data communication. Examples of the communication interface 645 include, but are not limited to, an integrated services digital network (ISDN) card, a modem, a local area network (LAN) card, an infrared port, a Bluetooth port, a zigbee port, and a wireless port.

In some embodiments, the processor 610 determines a time difference between initiation of an action corresponding to a first content provider and corresponding to a second content provider based on a content category. Further, the processor 610 initiates the action corresponding to the first content provider in response to an input associated with the first content provider. In addition, the processor 610 initiates the action corresponding to the second content provider in response to an input associated with the second content provider after a time equivalent to the determined time difference has elapsed.

In some embodiments, the processor 610 can include one or more processing units for performing one or more functions of the processor 610. The processing units are hardware circuitry performing specified functions.

Various embodiments facilitate bidding for time differentiated actions including time differentiated advertising. The time differentiated advertising provides advantages to an advertiser over other advertisers. Further, various embodiments enable advertisers who do not have a website to advertise.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method comprising:
receiving bids, electronically, for a content category from a first content provider and a second content provider;
determining a time difference between initiation of an action corresponding to the first content provider and corresponding to the second content provider based on the content category and the bids;
electronically initiating the action corresponding to the first content provider in response to an input associated with the first content provider; and
electronically initiating the action corresponding to the second content provider in response to an input associated with the second content provider after a time equivalent to the determined time difference has elapsed.

2. The method of claim 1, wherein the bids from each content provider comprise:
different bids for different actions.

3. The method of claim 1, wherein the action corresponding to the first content provider and the action corresponding to the second content provider comprise at least one of:
displaying contents of the first content provider and the second content provider to a prospective customer;
providing contact details of the prospective customer to at least one of the first content provider and the second content provider via communication instruments; and
establishing electronic communication between the prospective customer and at least one of the first content provider and the second content provider.

4. The method of claim 3, wherein establishing electronic communication comprises:
hiding contact details of the prospective customer from each content provider; and
hiding contact details of each content provider from the prospective customer.

5. A method comprising:
receiving bids, electronically, for a content category from a plurality of advertisers;
determining relative times for initiation of communication between a prospective customer and each advertiser based on the content category and the bids;
electronically providing advertisements of the plurality of advertisers in response to an input associated with the content category;
electronically initiating communication between a first advertiser of the plurality of advertisers and the prospective customer in response to an input indicative of selection of the first advertiser; and
electronically initiating communication between a second advertiser of the plurality of advertisers and the prospective customer in response to an input indicative of selection of the second advertiser after a predetermined time has elapsed.

6. The method of claim 5, wherein electronically providing advertisements comprises:
assigning a proxy number to each advertiser; and
displaying the proxy number of each advertiser.

7. The method of claim 5, wherein electronically providing advertisements comprises:
displaying advertisements of the first advertiser; and
displaying advertisements of the second advertiser after a predefined time has elapsed from the display of the advertisements of the first advertiser.

8. The method of claim 5, wherein:
electronically initiating communication between a first advertiser and the prospective customer comprises:
electronically forwarding contact details of the prospective customer to the first advertiser, and
electronically initiating communication between a second advertiser and the prospective customer comprises:
electronically forwarding contact details of the prospective customer to the second advertiser.

9. An article of manufacture comprising:
a machine readable medium; and
instructions carried by the machine-readable medium and operable to cause a programmable processor to perform:
receiving bids, electronically, for a content category from a first content provider and a second content provider;
determining a time difference between initiation of an action corresponding to the first content provider and corresponding to the second content provider based on the content category and the bids;
electronically initiating the action corresponding to the first content provider in response to an input associated with the first content provider; and
electronically initiating the action corresponding to the second content provider in response to an input associated with the second content provider after a time equivalent to the determined time difference has elapsed.

10. The article of manufacture of claim 9, wherein the bids from each content provider comprise:
different bids for different actions.

11. The article of manufacture of claim 9, wherein the action corresponding to the first content provider and the action corresponding to the second content provider comprise at least one of:
displaying contents of the first content provider and the second content provider to a prospective customer;
providing contact details of the prospective customer to at least one of the first content provider and the second content provider via communication instruments; and
establishing electronic communication between the prospective customer and at least one of the first content provider and the second content provider.

12. The article of manufacture of claim 11, wherein establishing electronic communication comprises:
hiding contact details of the prospective customer from each content provider; and
hiding contact details of each content provider from the prospective customer.

13. The article of manufacture of claim 12, wherein hiding the contact details of each content provider from the prospective customer comprises:
assigning a first proxy number to the first content provider;
assigning a second proxy number to the second content provider;
displaying the first proxy number when displaying the content of the first content provider; and
displaying the second proxy number when displaying the content of the second content provider.

14. The article of manufacture of claim 9, wherein:
electronically initiating the action corresponding to the first content provider comprises:
electronically providing an advertisement of the first content provider in response to an input associated with the content category, and
electronically initiating communication between the first content provider and a prospective customer in response to an input indicative of selection of the first content provider; and
electronically initiating the action corresponding to the second content provider comprises:
electronically providing an advertisement of the second content provider in response to the input associated with the content category, and
electronically initiating communication between the second content provider and the prospective customer in response to an input indicative of selection of the second content provider after the time equivalent to the determined time difference has elapsed.

15. The article of manufacture of claim 14, wherein:
electronically providing an advertisement of the first content provider comprises:
displaying one or more advertisements of the first content provider, and
electronically providing an advertisement of the second content provider comprises:
displaying one or more advertisements of the second content provider after a predefined time has elapsed from the display of the advertisements of the first content provider.

16. The article of manufacture of claim 14, wherein:
electronically initiating communication between the first content provider and a prospective customer comprises:
electronically forwarding contact details of the prospective customer to the first content provider; and
electronically initiating communication between the second content provider and the prospective customer comprises:
electronically forwarding contact details of the prospective customer to the second content provider.

17. A system comprising:
a communication interface in electronic communication with a plurality of electronic devices to receive bids for a content category from a first content provider and a second content provider;
a memory that stores instructions; and
a processor responsive to the instructions
to determine a time difference between initiation of an action corresponding to the first content provider and corresponding to the second content provider based on the content category and the bids;
to initiate the action corresponding to the first content provider in response to an input associated with the first content provider; and
to initiate the action corresponding to the second content provider in response to an input associated with the second content provider after a time equivalent to the time difference has elapsed.

18. The system of claim 17 further comprising a link to a communication system, and wherein the processor is responsive to the instructions to initiate the action corresponding to at least one of the content providers by sending an electronic message to that content provider through the link.

19. The system of claim 17, wherein the action corresponding to the first content provider and the action corresponding to the second content provider comprise at least one of:
providing advertisements of the first content provider and the second content provider in response to an input associated with the content category;
initiating communication between the first content provider and a prospective customer in response to an input indicative of selection of the first content provider; and
initiating communication between the second content provider and the prospective customer in response to an input indicative of selection of the second content provider after the determined time difference has elapsed.

20. The system of claim 19 further comprising a link to a communication system, and wherein the processor is responsive to the instructions
to provide the advertisements of the first content provider and the second content provider through the link; and
to initiate the communication of at least one of the first content provider and the second content provider with the prospective customer by sending an electronic message to the prospective customer through the link in response to an input indicative of selection of at least one of the first content provider and the second content provider.
